(19) United States
(12) Patent Application Publication
(10) Pub. No.: US 2008/0183113 A1
(43) Pub. Date: Jul. 31, 2008

(54) Massaging Device

(75) Inventors: Kazem Kazerounian, Storrs, CT (US); Wei Guo, Unionville, CT (US)

Correspondence Address: STOUT, UXA, BUYAN & MULLINS LLP, 4 VENTURE, SUITE 300, IRVINE, CA, 92618, US

(73) Assignee: OSIM INTERNATIONAL LTD., SINGAPORE (SG)

(21) Appl. No.: 11/793,172

(22) PCT Filed: Dec. 16, 2004
(86) PCT No.: PCT/US2004/042219

§ 371 Date: Nov. 7, 2007

(51) Int. Cl. A61H 15/00

(52) U.S. Cl. 601/99

(57) ABSTRACT

A massaging device with a variable surface for providing a good general massage that includes one user support surface (1), a structural support frame (2) and at least one dimensionally varying device (3). In one embodiment, the dimensionally varying device may be an airbag. At least one airbag is situated in between the user support surface and the structural support frame. The airbag utilizes a fluid that is either liquid or gaseous in nature to vary its dimensions. By the varying the dimensions of the airbag, the massage forces experienced by a user is indirectly varied. This embodiment can be used in a chair, bed or any other surface that is in contact with a user for the purposes of a massage. It may further include a pressure regulator for the fluid and force detection sensors so as to provide real-time feedback to the user as the massage progresses.

The present invention relates to a massaging device that, for example alleviates back and joint ailments, promotes blood circulation, eases muscle strain and stiffness and further serves as a means of relieving stress, tiredness and fatigue by providing a relaxing massage. More specifically, the present invention relates to a massaging device that comprises a variable user support surface.

Massage devices of various sorts have been used extensively to address the problems that people have with regards to aches, pains and relief from the stress of everyday life. Amongst these, chair-type and bed-type massaging devices that serve the same purpose are presently available.

Essentially, the above-mentioned massaging devices have several common characteristics. For example, they usually comprise of a surface upon which a user would sit or lie on. In the case of massage chairs, such a surface is often cushioned. Beneath this cushioned layer the massage devices rely on the use of manipulators to provide the needed muscular stimulation to the user. These manipulators are usually actuated by means of motors, hydraulics or pneumatics. Such devices have been disclosed by U.S. Pat. No. 6,752,772, U.S. Pat. No. 6,517,500, U.S. Pat. No. 5,762,618 and PCT application WO 03/022197 for example. Dynamic actuation is necessary in order for the manipulators to generate and transmit tapping (or knocking), kneading and rolling effects to the user for the duration of the massage.

Apart from the generation of massaging effects, such mechanical actuators also allow the manipulator to translate about a given axis. In more complex and usually costlier massaging device models, a three-dimensional translation is even possible. This means that the manufacturing of such a device would have to include complex controllers, force feedback sensors and actuator systems. Such components may cause the cost of the said massaging devices to be high and hence, unaffordable to many. In addition, an undesirable side effect is that users are often not able to effectively control the massage forces that the device exerts upon them.

In some massage devices, air is used in place of a mechanical manipulator or air is used to actuate a mechanical manipulator. In the former, air is used to inflate and deflate particular sections of the region surrounding the user so as to provide the desired muscle stimulation to the user. Such a device is disclosed in U.S. Pat. No. 5,762,618, for example. This document describes a massage chair that has inflatable and deflatable airbags for massaging a user by means of an expansion and contraction of the said airbags. As for the latter case, where air is used to actuate a manipulator, U.S. Pat. No. 6,517,500 discloses a chair wherein the manipulators are driven into the back of a user by means of a pneumatic actuation device. With pneumatically actuated devices or pneumatic manipulators, the intensity of the massage is difficult to control as the dynamic range of the forces exerted by such pneumatic devices is rather limited.

PCT application WO 03/022197 discloses a massage chair that comprises a structure to support a human body and a massaging unit that also utilizes the continuous inflation and deflation of airbags that are placed directly behind a user. The manipulators, in the form of inflatable chambers, are dispersed over the entire portion of the back support. This results in the production of a massaging effect upon the back of the user. The massaging device, as disclosed, relies solely upon the movements of the inflatable chambers to stimulate the thoracic and lumbar regions of the body. This means the chambers are in direct contact with the user and hence, are directly responsible for massaging the user. Specific localized massaging action over small areas may not be possible in this instance. Furthermore, with the use of air as the actuating and manipulating device, the massaging intensity, as mentioned above, has a rather limited range. So, it is unlikely that the user would be able to effectively control the massage force that is applied upon him should he require a varying massaging force.

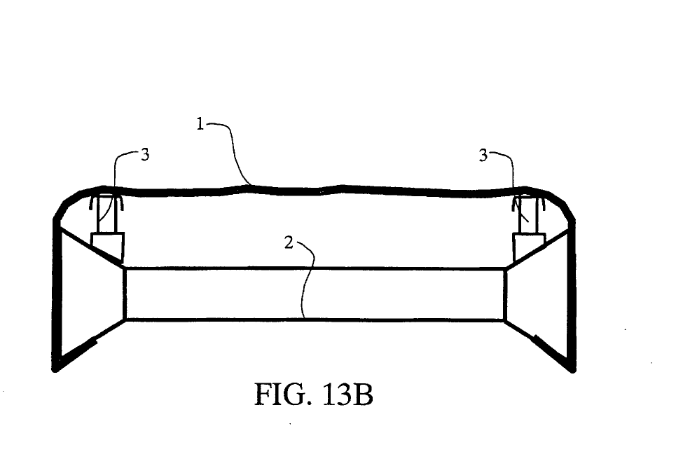

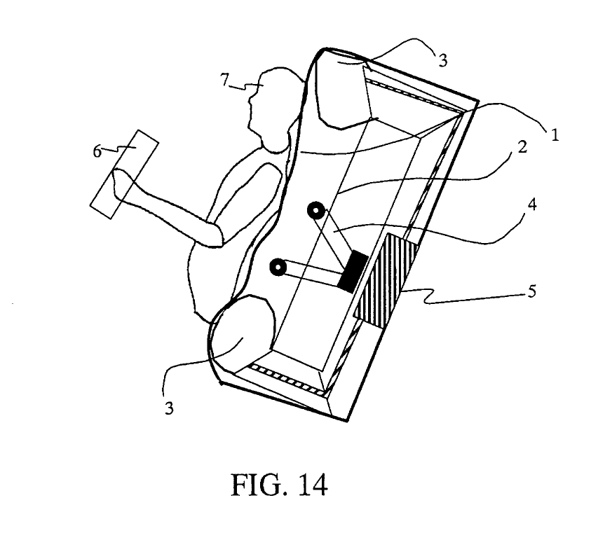

The device as disclosed by U.S. Pat. No. 6,752,772 adopts a mechanical manipulator as seen in FIGS. 43 and 44 of the document. The device further comprises an inflatable pad located between the user and a massage chair. Support for the thoracic, and lumbar regions of the back may not be adequate, as the air pad appears not to expand uniformly. The spinal column may be prone to distortion as the airbag is inflated directly behind the user. Unnecessary distortion may possibly result in the aggravation of a prior injury or result in the formation of new injuries in the spinal and lower lumbar regions of a user. This may be the case, as the massaging manipulator in this design, needs to contact the body of the user through the air bag thereby further distorting the massage effect. Yet another possible disadvantage of the device, as seen in FIGS. 43 and 44 of U.S. Pat. No. 6,752,772 is that the air pressure in the air bag may need to be very high in order to have any significant effect in reducing the massaging force.

Different users will inevitably have different massage requirements. Depending upon the needs of an individual, they may require different intensities of massage forces at various times during a massage program consisting of the various mechanical massaging motions of rolling, kneading, tapping and vibrating. As each individual has different tolerances towards the amount of force exerted by different massaging devices, what is needed is a means by which a user may actively control the intensity of the applied massage forces to his body for the duration of the massage.

However, the presently known massaging devices lack a suitable and cost effective means of varying the force exerted upon the user during the massage. Accordingly, there is a need for a massage device with an adjustable massage force that spans a wide range of values and is yet economical and easy to manufacture. It is therefore an objective of the invention to provide such a massaging device. A massaging device as defined by the independent claim achieves this objective.

Such a massaging device comprises a variable user support surface to be in contact with a user. The variable user support surface at least partially encompasses (or surrounds) a frame. The frame provides structural support and is located beneath the user support surface. At least one dimensionally variable means is located at least partially in-between the user support surface and the frame such that a dimensional variation of the dimensionally variable means exerts a force on the user support surface resulting in the distance from the frame to the user support surface to vary.

Accordingly, the present invention allows a user of the massage device to vary the surface tension of the user support surface and thereby indirectly allows a user to vary the massage forces experienced even though the force applicators may geometrically be in the same position and continue to apply a constant force. The principle behind the invention is that the force exerted upon a user by the force applicators of a massaging device is largely dependent on the force that the user exerts upon tile massaging device (due to the weight of the user, for example) less that portion of the force that is exerted by the user on the other parts of the massaging device (other than force applicators), namely, the user support surface. In other words, the force a user exerts on the massaging device is counteracted by the sum of the forces of the force applicators and the user support surface of the massaging device. An increase or decrease in the magnitude of the massaging force can be controlled by the extent to which the user support surface bears the weight of the user. The present invention allows the user to have control over the extent to which the user support surface of the massaging device supports his/her weight and hence, to have control over the massage intensity experienced by the user.

In the massaging device, the dimensionally variable means may be any means that is able to vary the distance between the user support surface and the frame. Suitable examples include mechanical means, hydraulic means, pneumatic means and magnetic means. For example, mechanical means includes a spring-loaded actuator, a roller mechanism or a lever-arm mechanism. Pneumatic means may include but are not limited to air cylinders (which usually are of circular shaped tubes), airbags, inflatable cushions or inflatable tubes of other geometric shapes such as accordion-type shapes, for example. Hydraulic means includes a hydraulically driven spring actuator, a hydraulically driven lever arm or a hydraulically driven roller mechanism, for example. Finally, suitable magnetic means may be a magnetically actuated solenoid plunger, a spring actuator driven by a solenoid plunger or a lever arm mechanism driven by a solenoid plunger, for example.

The dimensionally variable means may be attached directly to the frame. This enables the dimensionally variable means to use the frame as a support during its dimensional varying phase. Alternatively, the dimensionally variable means may also be attached to the underside of the user support surface or to both the user support surface and the frame. This achieves the same purpose of providing the dimensionally variable means with possible anchor points during its dimensionally varying phase.

In one embodiment, the dimensionally variable means is, for example, an airbag. As such, it allows for the dimensionally variable means to have a flexible shape as opposed to having a rigid one. Furthermore, the airbag can be placed in several different locations between the user support surface and the frame. This provides the added advantage of providing additional support to the user of the massage device without having to alter the underlying schematics of the device thereby providing a cost effective solution to the existing problem of control over the massaging forces experienced by a user. Another aspect of having a non-rigid dimensionally variable means is to allow for the use of a variety of fluids in order to vary the given dimensions.

As the principle and design of the present invention is simple, the above-mentioned main features of a user support surface, a frame and a dimensionally variable means may be incorporated into either chair-type massaging devices or bed-type massaging devices. This is possible as the three basic features namely, the user support surface, the frame and the dimensionally variable means can be easily adapted, design wise, to fit into either the backing of a massage chair or into a mattress of a bed.

The arrangement of the dimensionally variable means may be along the periphery of the frame. At least one dimensionally variable means may be used. Alternatively, the at least one dimensionally variable means may also be situated along the underside of the periphery of the user support surface. In order to achieve an optimal level of control over the exerted massage forces, a symmetrical arrangement of at least two dimensionally variable means is also possible. Where an additional means of control over the exerted massage forces is necessary, for example in the cervical spine region (neck), additional dimensionally variable means to facilitate a more precise control over the massage forces may also be positioned in an asymmetrical manner.

Also in the embodiments where the dimensionally variable means is a mechanically, hydraulically or magnetically actuated means, as mentioned above, it is sufficient to use at least one means. The dimensionally variable means, in these embodiments, may also be positioned in either a symmetrical arrangement or if necessary, where additional support and control is required, in an asymmetrical manner.

In a further embodiment, the dimensionally variable means is in the form of an airbag. The airbag may be positioned away from the periphery, that is, extending inwards away from the edge at any location between one peripheral edge to the next. Such an arrangement may have the advantage of allowing a user to not only control the overall massage forces exerted upon him but simultaneously, it would confer upon him the ability to distribute the massage intensity. For example, such an arrangement allows a user to have higher massage intensity on the lower lumbar region while maintaining a lower level of massage intensity on perhaps the upper thoracic region of the back while undergoing a single massage program.

A further advantage of using an airbag, or any other inflatable pneumatic means such as an inflatable cushion, is that it provides the flexibility of using a variety of fluids to achieve the effect of varying the required dimensions. When using such a pneumatic means, one fluid of choice would be a gas. The gas selected may be, but is not limited to, any one of the following:
Air
Nitrogen gas (N₂)
Any one of the Noble gases
   In addition, if a gas is used, it may be preferred that the pneumatic means such as an airbag and/or the user support surface have a semi-permeable membrane that would allow for the controlled release of the gas so as to create a convection current whereby heat from the body of the user is removed via the permeating air from behind the body of the users, thus resulting in a cooling effect.

Another advantage of using a gaseous fluid is that it may be preferred to act as a carrier for a scent that can be released from a vial within the used pneumatic means and different scents can be incorporated so that a user may select the desired scent in accordance with a particular mood. The gas, acting as a carrier, through the semi-permeable membrane, could then transport the selected scent and supplement the varying massage forces by providing a form of aromatherapy.

Alternatively, the fluid may also be a liquid. In this instance, it is preferred that the liquid comes in the form of water or any other liquid with has similar properties and is non-toxic.

In a further embodiment, the massaging device may include a heating element. The heating element may be situated between the dimensionally variable structure and the frame and may comprise but is not limited to a material such as carbon fiber, a metal such as nickel, iron, chromium, aluminum or any alloy thereof. In such an embodiment, the heating element may supplement the massage program by supplying heat to the body of a user. For this purpose, heating can take place via directly heating a thermally conductive user support surface or by heating an intermediate fluid medium to enhance the massaging effect. Applying heat to muscular regions produces varying effects according to the degree of heat applied. A mild degree of heating is effective in relieving pain. Heat also increases the blood flow of blood by dilating the capillaries and arterioles. A further advantage of heating is that the heat causes an increased muscle and ligament extensibility thereby enhancing easier stretching and facilitating muscle contractility.

In another embodiment, the heating element may be placed within a dimensionally variable structure such as an airbag. In this arrangement, the heating element may also be used to vaporize extracts such as Eucalyptus, Thyme or Menthol but are not limited to these. The vapors then permeate out of the semi-permeable membrane of the user support surface (as previously described) and possibly, provide relief from congestion, asthma, and other respiratory problems of a user.

Accordingly, it is preferred, in embodiments that include a pneumatic means, that the massage device will include a pump to transport the designated fluid into or out of the pneumatic means such as an airbag. It is also preferred that the pump will comprise of a pressure sensor to monitor the amount of fluid entering or leaving, for example, the airbag in real-time. It may further comprise a dynamic pressure controller that allows the user to adjust the pressure within the airbags and therefore also adjust the massage forces exerted upon the user.

In general, and for all dimensionally variable means, a dynamic force controller can be used to vary the massage force exerted on a user by the force applicators. The weight of a user, the angle at which a user is inclined at and the desired intensity as selected by the user are examples of parameters that have an influence over the massage force to be exerted. Accordingly, the dynamic force controller is adapted to control the dimensions of the dimensionally variable structure by factoring in the parameters as the ones mentioned above.

The controller may be operated by a program selector that allows the user to choose a desired massage program based upon his needs. The interfacing of the program selector with the controller may be carried out by connecting the controller via an electrical cable or by wireless means to the program selector. Wireless means include infrared beams or radio transmissions to send program selections from the program selector to the dynamic pressure controller. By interfacing the controller as such, pre-programmed massage programs within the program selector are able to instruct the controller to vary the force intensity according to the various portions of the selected massage program. This results in a massage program that allows complex massage patterns wherein each massage program and massage pattern may further comprise of varying massage force intensities that are distributed across different parts of the body of a user. Specifically, at least three program modes may exist within the program selector namely, the “Manual”, “Auto” and “Users” program modes. Generally, in the “Manual mode, a user may adjust the massage intensity to suit his preferences. In the “Auto” mode, as described above, comprises of preprogrammed settings relating to the massage intensity and patterns. The “Users” mode allows a user to customize the massage intensity and sequence, both of which may be can be programmed into the controller via the program selector interface.

The user support surface may comprise of at least one layer of material wherein the layer of material may be one that is commonly used for the manufacture of such massage devices. This material may comprise but is not limited to sponge, leather, vinyl or some similar material that would provide additional comfort and support to the user, for example.

The massaging device further comprises at least one or more force applicators. Any suitable force applicator known in the art can be used. Suitable examples include those force applicators that are disclosed in U.S. Pat. No. 6,752,772 or in U.S. Pat. No. 6,517,500. It is also possible to use airbags as force applicators as disclosed in PCT application WO 03/022197. The force applicators are able to perform rolling, kneading, tapping and vibrating motions. Such motions serve to stimulate the muscular regions of the user. Where suitable, force applicators may further comprise of a wheel whose hardness may also be varied by means of a magneto-theological fluid. The massage wheel may vary its application pressure by means of elastic means and by means of a changeable preload.

The accompanying drawings will serve to further illustrate that as mentioned in the description. They will also serve as an illustration to the preferred embodiments and the detailed explanation that follows will aid in the understanding of the principle behind the present invention.

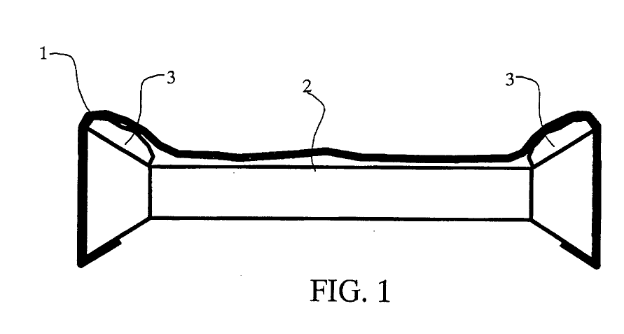

FIG. 1 is a cross-sectional view of a first embodiment of the massaging device and as such, illustrates the user support surface, frame and airbags, as an example of a pneumatic means used as a dimensionally variable structure, in the deflated position.

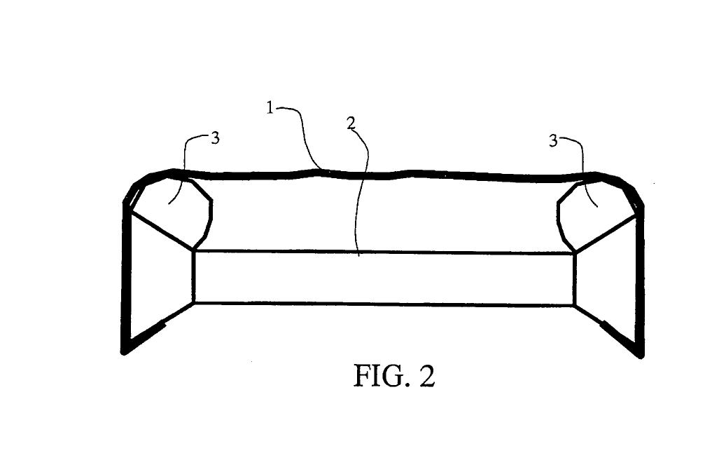

FIG. 2 is a cross-sectional view of the device shown in FIG. 1 with the airbags in the inflated position thereby creating a state of tension within the user support surface.

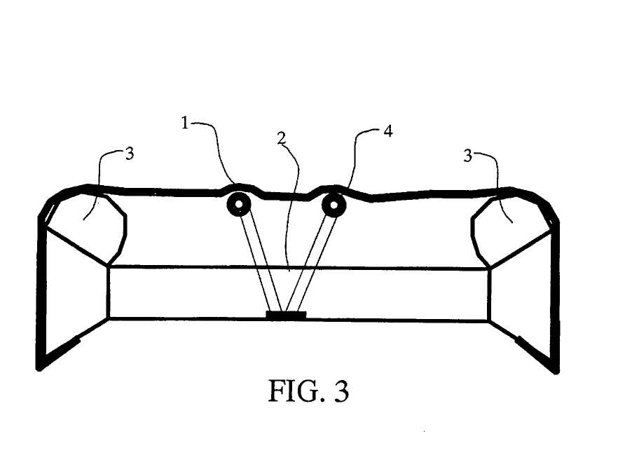

FIG. 3 is a cross-sectional view of FIG. 2 and shows a second embodiment of the massaging device of the invention comprising a pair of force applicators with the airbags in the inflated position.

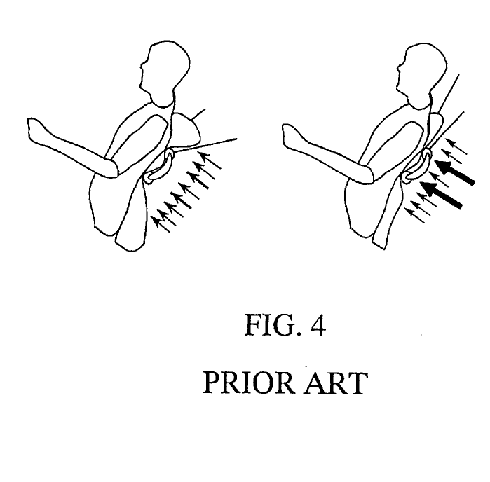

FIG. 4 shows a prior art massaging device wherein an airbag is illustrated as being in direct contact with the user.

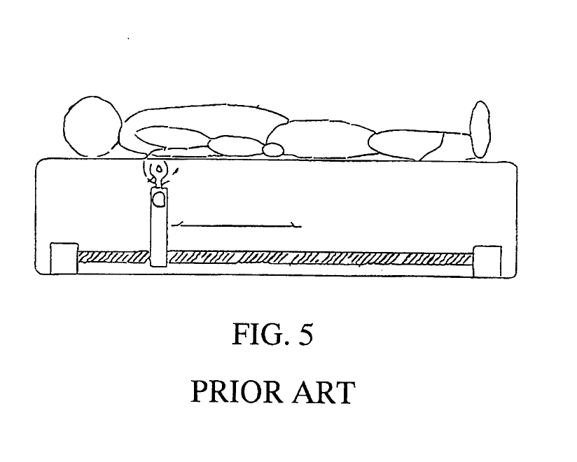

FIG. 5 illustrates a prior art massaging device where the manipulator is incorporated within the inflatable structure.

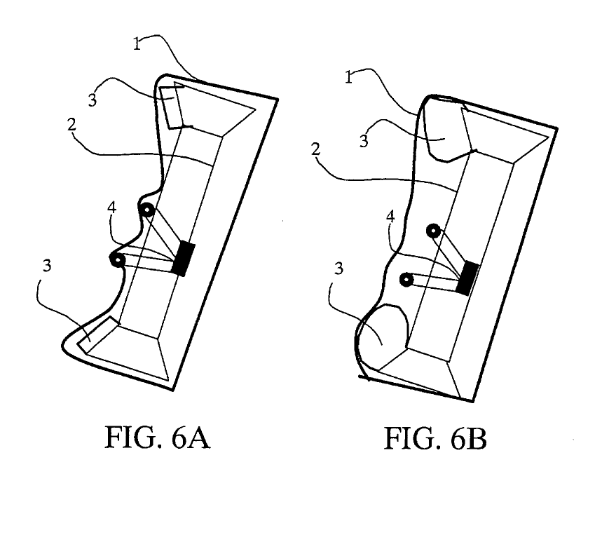

FIG. 6A is a third embodiment of the massaging device disclosed and shows a cross-sectional view of the side of a backing of a chair-type massaging device with the airbags in a deflated position.

FIG. 6B is a further illustration of the embodiment in FIG. 6A with airbags inflated and the user support surface stretched.

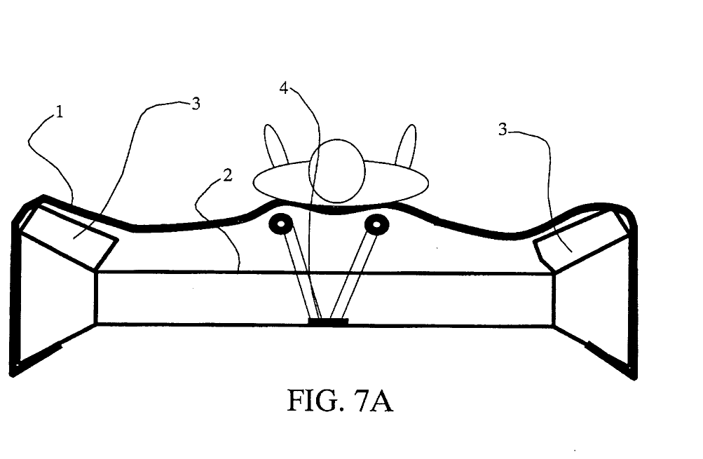

FIG. 7A is a cross-sectional view of a fourth embodiment of the massaging device of the invention where the airbag is deflated and force applicators are incorporated into the embodiment.

FIG. 7B is a further illustration of the embodiment in FIG. 7A with airbags inflated.

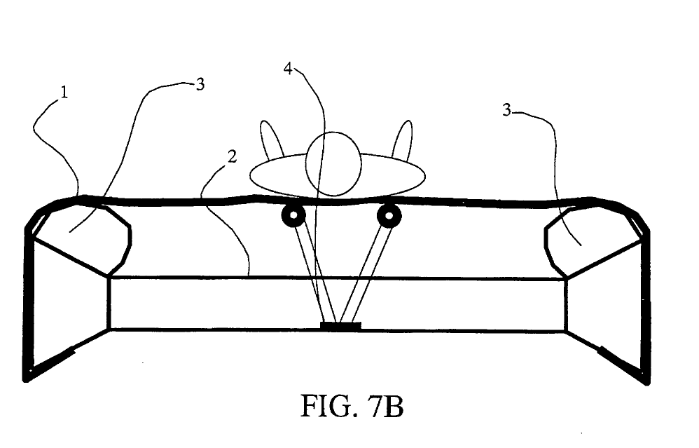

FIG. 8 shows the possible positioning of two airbags via a frontal view of the back support of a chair-type massage device and a cross-sectional view of the same taken along line W-W showing the back support inclined at an angle θ. The other elements of the massaging device are not shown in order that the positioning of the airbags is represented clearly.

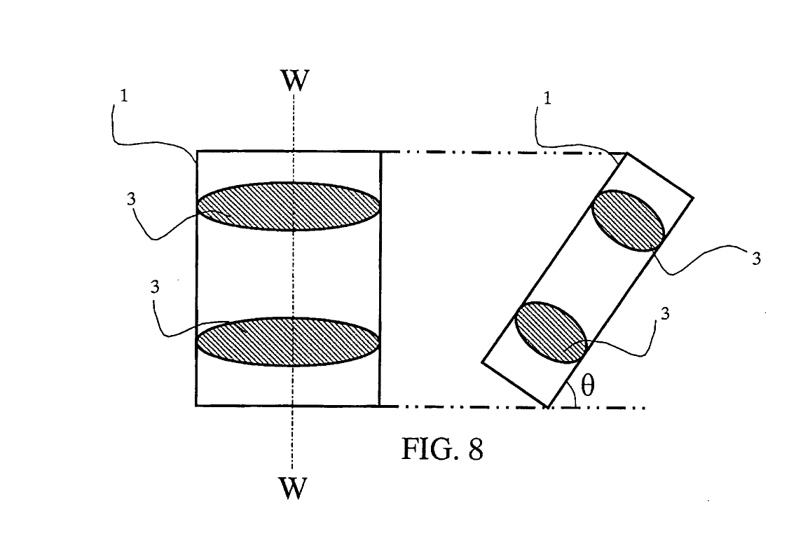

FIG. 9 shows a further possible positioning of two airbags via a frontal view of the back support of a chair-type massaging device and a cross-sectional view of the same taken along line X-X showing the back support inclined at an angle θ. The other elements of the massaging device are not shown in order that the positioning of the airbags is represented clearly.

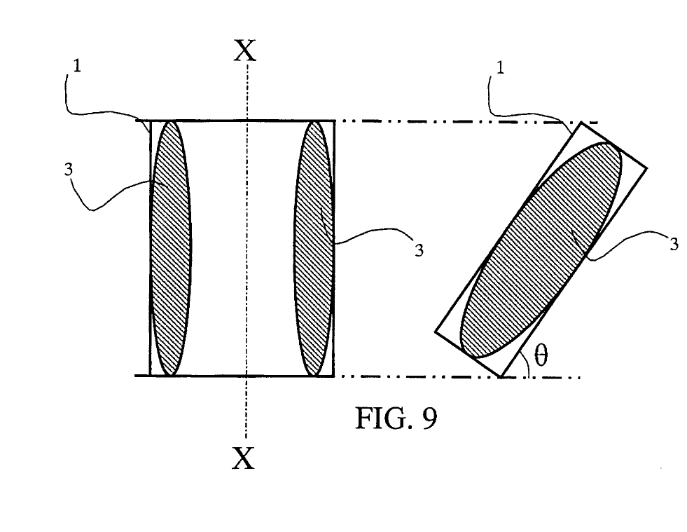

FIG. 10 shows the possible positioning of four airbags via a frontal view of the back support of a chair-type massaging device and a cross-sectional view of the same taken along line Y-Y showing the back support inclined at an angle θ. The other elements of the massaging device are not shown in order that the positioning of the airbags is represented clearly.

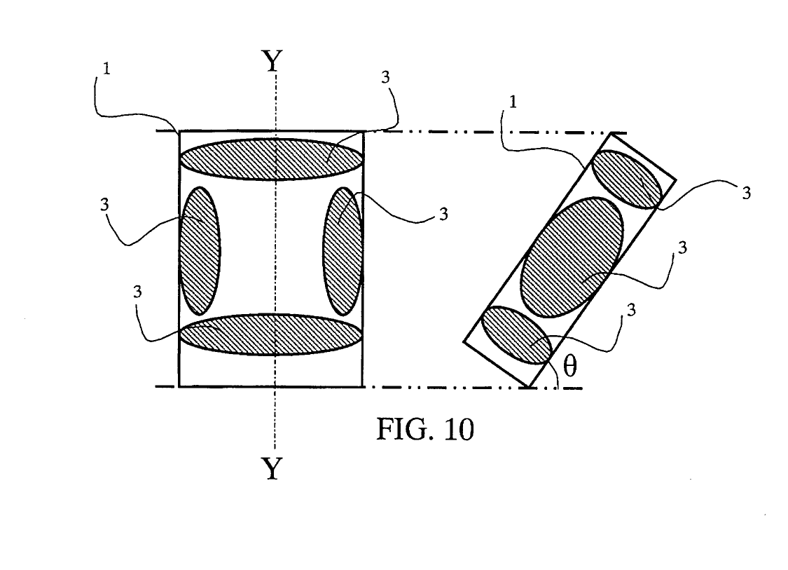

FIG. 11 shows the possible positioning of six airbags via a frontal view of the back support of a chair-type massaging device and a cross-sectional view of the same taken along line Z-Z showing the back support inclined at an angle θ. The other elements of the massaging device are not shown in order that the positioning of the said airbags is represented clearly.

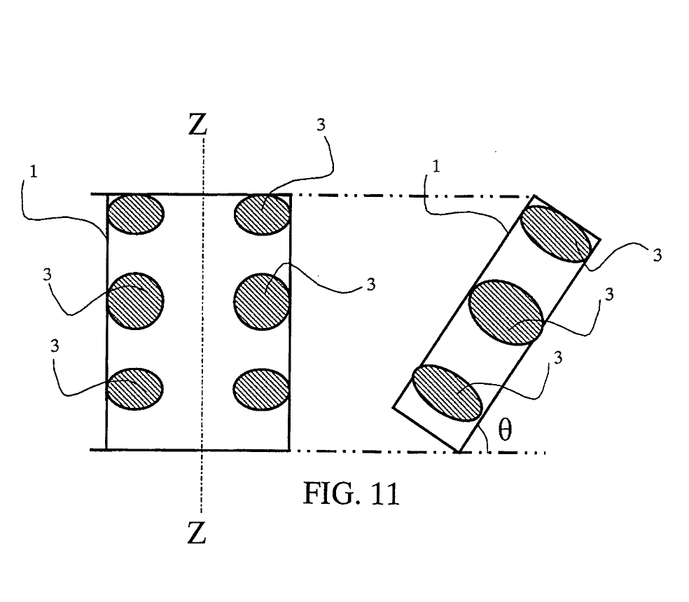

FIG. 12 shows the possible positioning of one airbag via a frontal view of the back support of a chair-type massaging device and a cross-sectional view of the same taken along line A-A showing the back support inclined at an angle θ. The other elements of the massaging device are not shown in order that the positioning of the said airbag is represented clearly.

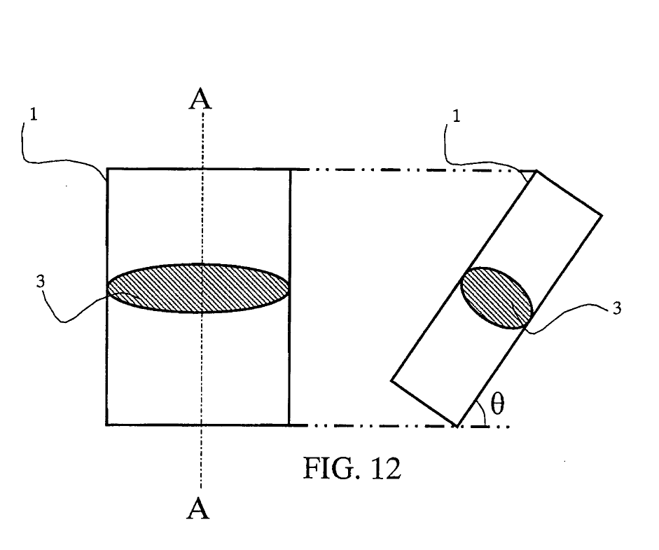

FIG. 13A is a cross-sectional view of a fifth embodiment of the massaging device and as such, illustrates the user support surface, frame and mechanical actuators as another example of a suitable dimensionally variable structure in the collapsed position.

FIG. 13B is a cross-sectional view of the device shown in FIG. 13A with the mechanical actuators in the extended position thereby creating a state of tension within the user support surface.

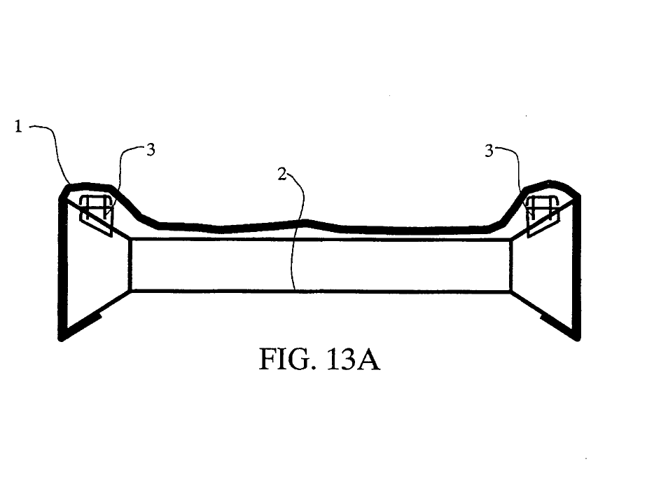

FIG. 14 is a side cross-sectional view of the backing of a chair-type massaging device with the airbags in an inflated position with the user illustrated as holding a wireless (or wired) program selector.

With reference to the figures, exemplary embodiments of the invention are shown.

FIG. 1 is a cross-sectional view of a massaging device with that comprises a variable surface user support surface 1, a frame 2 that is located beneath the user support surface 1 and at least one dimensionally variable means 3. When the dimensionally variable means 3 is not inflated, the user support surface 1 is not in a state of tension and can be seen to be essentially conforming to the frame 2.

The user support surface 1 is attached to the frame 3. As shown in this embodiment, the user support surface 1 may partially encompass the entire frame 2. In FIG. 1, where the user support surface 1 covers the frame partially, the user support surface 1 is attached to the periphery of the frame 2.

The dimensionally variable means 3 as shown in FIG. 1 is located at least partially in-between the user support surface 1 and the frame 2. The dimensionally variable means 3 may be attached to the frame 2 or to the underside of the user support surface 1 or to both contact surfaces.

FIG. 2 is a cross-sectional view of the device when the dimensionally variable means 3 is fully inflated. The user support surface 1 no longer conforms to the frame 2 but enters into a state of tension. The inflation of the dimensionally variable means 3 causes the user support surface to stretch thereby lifting it up and away from the frame, significantly reducing the concave shape it was in as seen in FIG. 1

FIG. 3 shows a second embodiment of the massaging device. In this embodiment, the dimensionally variable means 3 are airbags 3 that are shown in a fully inflated state. Mechanical force applicators 4 are incorporated and attached to the frame. The force applicators 4 consist of at least two shafts that culminate with a massage wheel affixed at the end of each shaft.

FIG. 4 shows an illustration of a prior art massaging device where the inflatable pad is in direct contact with the back of a user and massage wheels are applied directly to the airbags. The figure shows both the inflated and deflated positions of the airbags and the associated pressure distributions for the respective cases.

FIG. 5 shows a prior art massaging device where the illustration is a bed wherein the massage wheel is located within the mattress that is essentially, a large device. The massage wheel translates horizontally and by doing so, provides the user with a massage.

FIG. 4 may perhaps serve as a means of varying the pressure exerted upon a user of a massaging device. It attempts to achieve this by positioning the inflatable pad in direct contact with the user so as to vary the position of the user. In FIG. 5, the manipulators are located within the mattress and have no means of varying the pressure exerted upon the user. Thus when the disclosed massaging device of the invention is compared against the two prior art illustrations, it is clear that the present invention is novel and inventive over the prior art.

FIG. 6A shows a third embodiment. In this embodiment, the illustration is a cross-sectional view of the backing of a chair-type massage device. In FIG. 6A, the user support surface 1 conforms essentially to the frame 2 and to the force applicators 4. The airbags 3 are not inflated.

In FIG. 6B, the airbags 3 are fully inflated and the user support surface 1 now taut. The force applicators 4 now influence the shape of the user support surface 1 to a lesser extent. The distance of the user support surface 1 to the frame 2 and the force applicators 4 has increased as compared to FIG. 6A.

The force a u ser exerts on the massaging device i s counteracted by the sum of the forces of the force applicator and the user support surface of the massaging device. If a user is initially seated in a chair-type massage device according to the embodiment as shown in FIG. 6A, his weight would be substantially borne by the force applicators 4 giving him the feeling that the massage forces applied by the force applicators 4 are of a high intensity. If a user were seated in the embodiment as shown in FIG. 6B, his weight would be essentially supported by the user support surface 1 instead of the force applicators. The massage force experienced by a user now would decrease. Thus, by varying the extent to which the airbags 3 are inflated, a user is able to vary the massage forces that are experienced by him.

Another embodiment is that of a bed-type massage device as illustrated in FIG. 7A. In this embodiment, the massaging device is similar to that of FIG. 2 but of larger dimensions. Similarly, FIG. 7A is a cross-sectional view of the massage device when the airbags 3 are not inflated. The user support surface 1 essentially conforms to the frame 2 and to the user. Mechanical force applicators 4 are attached to the frame 2. The force applicators 4 consist of at least two shafts that culminate with a massage wheel affixed at the end.

FIG. 7B shows the embodiment as described in FIG. 7A with the airbags 3 being fully inflated. A smaller area of the back of a user back is on the region of contact with the force applicators 4.

FIG. 8 shows the front view and a cross-sectional view along line W-W of the back support in the embodiment of a chair-type massage device. The positioning of the dimensionally variable means 3 is shown as an elongated tube-like structure. In the embodiment when only two are used, the first dimensionally variable means 3 is placed such that it extends horizontally from one peripheral edge across to the other. In a similar fashion, a second dimensionally variable means 3 is placed as mentioned above but in a lower position to support the lumbar region of the back.

FIG. 9 shows the front view and a cross-sectional view along line X-X of the back support in the embodiment of a chair-type massage device. Again, the positioning of the dimensionally variable means 3 is shown as an elongated tube-like means. In this embodiment where only two are used, the two dimensionally variable means 3 are placed along the peripheral of the user support surface l such that their ends extend vertically from one peripheral edge to the next.

FIG. 10 shows the front view and a cross-sectional view along line Y-Y of the back support in the embodiment of a chair-type massage device. In this preferred embodiment, four dimensionally variable means 3 are used. The first two are placed as shown previously in FIG. 8. The other two dimensionally variable means 3 are placed as in FIG. 9 except that they do not extend vertically from one peripheral edge to the next.

FIG. 11 shows the front view and a cross-sectional view along line Z-Z of the back support in the embodiment of a chair-type massage device. In this embodiment, six dimensionally variable means 3 are arranged in a vertically symmetrical manner about line Z-Z.

FIG. 12 shows the front view and a cross-sectional view along line A-A of the back support in the embodiment of a chair-type massage device. The positioning of the dimensionally variable means 3 is shown as an elongated tube-like stricture. In this embodiment where only one is used, the dimensionally variable means 3 is placed such that it extends horizontally from one peripheral edge across to the other.

In order to enhance the clarity with regards to the positioning of the dimensionally variable means, the frame beneath the user support surface for the FIG. 8-12 is not shown but should be considered as being present within the user support surface 1.

FIG. 13A is a cross-sectional view of a massaging device as shown in FIG. 1 with spring-loaded mechanical actuators 3. When the mechanical actuators 3 are in a collapsed position, the user support surface 1 is not in a state of tension and can be seen to be essentially conforming to the flame 2.

FIG. 13B is a cross-sectional view of the device when the spring-loaded mechanical actuators 3 are in the expanded position. The user support surface 1 no longer conforms to the frame 2 but enters into a state of tension. The expansion of the spring-loaded mechanical actuators 3 causes the user support surface to stretch thereby lifting it up and away from the frame, significantly reducing the concave shape it was in as seen in FIG. 1

FIG. 14 is a cross-sectional view of the backing of the massaging device at an inclined angle with the user 7 as shown leaning on the user support surface 1. The airbags 3 are in the inflated position causing the user support surface 1 to conform to the force applicators 4 and frame 2 to a lesser extent by varying the distance between the user support surface 1 and the frame 2 and force applicators 4. At this instance, the user support surface 1 supports a greater proportion of the weight of the user 7. The user 7 is illustrated holding a program selector 6, which is linked via a wireless (or wired) connection to a dynamic pressure controller 5. The dynamic pressure controller 5 senses the weight of the user 7 and constantly adjusts the pressure in the airbags 3 such that it either increases (via deflation) or decreases (via inflation) the massaging forces experienced by the user 7.

The presently claimed invention comprises of the above-mentioned arrangements of the dimensionally varying means as well as any other combinations of locating the dimensionally varying means in such a manner so as to achieve the objective of the invention as is presently claimed.

1-30. (canceled)

31. A massaging device comprising:
a variable user support surface to be in contact with a user,
a frame that is located beneath the user support surface, wherein the user support surface at least partially encompasses the frame,
at least one force applicator attached to the frame to apply a massaging force to the user through said variable user support surface, and
at least one inflatable member comprising a gas to vary its dimensions, located at least partially in-between the user support surface and the frame, and along the peripheral of said frame, such that a dimensional variation of said member varies the surface tension of the user support surface resulting in the distance from the frame to the user support surface to vary.

32. The massaging device according to claim 31, wherein the at least one inflatable member is attached to the frame.

33. The massaging device according to claim 31, wherein the at least one inflatable member is attached to the user support surface.

34. The massaging device according to claim 31, wherein the inflatable member is selected from the group consisting of an airbag, an inflatable tube and an inflatable cushion.

35. The massaging device according to claim 31, wherein the massaging device is a chair or bed.

36. The massaging device according to claim 31, wherein the at least one inflatable member is arranged along the peripheral of the frame symmetrical to another at least one inflatable member.

37. The massaging device according to claim 31, wherein the at least one inflatable member is arranged along the peripheral of the frame asymmetrical to another at least one inflatable member.

38. The massaging device according to claim 31, wherein the at least one inflatable member is arranged such that it extends horizontally from one peripheral edge of the frame across to the other.

39. The massaging device according to claim 31, wherein the at least one inflatable member is arranged such that it extends vertically from one peripheral edge of the frame across to the other.

40. The massaging device according to claim 31, wherein the gas is selected from a group consisting of air, nitrogen gas (N₂) and noble gases.

41. The massaging device according to claim 31, wherein the massaging device further comprises a heating element.

42. The massaging device according to claim 41, wherein the heating element comprises a material selected from the group consisting of carbon fiber, a metal such as nickel, iron, chromium, aluminum or alloys thereof.

43. The massaging device according to claim 31, further comprising a pump to transport the gas into or out of the inflatable member.

44. A massaging device according to claim 43, wherein the pump includes a pressure sensor for the gas contained in the inflatable member and a dynamic pressure controller.

45. A massaging device according to claim 44, wherein the dynamic pressure controller is interfaced with a program selector that is pre-programmed with massage patterns.

46. A massaging device according to claim 31, wherein the user support surface comprises at least one layer of material wherein the layer of material is attached beneath the user support surface.

47. A massaging device according to claim 31, wherein the at least one force applicator is located beneath the user support surface and is capable of moving in at least one dimension.

48. A massaging device according to claim 47, wherein the at least one force applicator further comprises a massage wheel made of a material whose hardness is varied by means of a magneto rheological fluid.

49. A massaging device according to claim 47, wherein the at least one force applicator further comprises a massage wheel whose application pressure is varied by means of elastic structures and preloading.

50. A massaging device according to claim 48, wherein the at least one force applicator further comprises a massage wheel whose application pressure is varied by means of elastic structures and preloading.
